(19) United States
(12) Patent Application Publication
(10) Pub. No.: US 2026/0291159 A1
(43) Pub. Date: Sep. 24, 2026

(54) GROMMET STATION

(71) Applicant: Komax Holding AG, Dierikon (CH)

(72) Inventors: Dieter Vischer, Zug (CH); Franco De Bastiani, Thalwil (CH); Benno Hafliger, Luzern (CH)

(21) Appl. No.: 18/868,805

(22) PCT Filed: Jun. 2, 2022
(86) PCT No.: PCT/EP2022/025261

§ 371 Date: Nov. 25, 2024

(51) Int. Cl. H01R 43/00; H02G 15/013

(52) U.S. Cl. CPC H01R 43/005; H02G 15/013

(57) ABSTRACT

A grommet station includes a grommet fitting unit for fitting cable ends with grommets, a grommet providing unit and a support structure supporting the grommet fitting unit and the grommet providing unit. The grommet fitting unit and the grommet providing unit are permanently interconnected, wherein the grommet fitting unit and the grommet providing unit form a joint exchangeable module that can be coupled to and uncoupled from the support structure.

### FIELD

The invention relates to a grommet station for fitting grommets to cables. With such grommet stations, grommets, which are required for example for moisture-tight feedthroughs of electrical cables through connector housings or housing walls of electrical appliances, can be applied to cables in an economical manner.

### BACKGROUND

Grommets are sealing elements made of silicone, for example, which are generally used to seal connector housings. In the production of cables, cable may be cut to length and stripped, fitted with grommets, crimped, and optionally provided with housings. For this purpose, a stripped cable is fitted with a grommet, and then, usually, a metal contact is crimped. This crimp contact is designed so that it fastens the grommet on the cable. The grommet fitting is carried out on fully automatic cable assembly systems with grommet fitting stations, wherein the grommets usually are added to the grommet fitting station as bulk material. Semi-automatic machines for cable assembly systems are also known (here, the cable is inserted by hand), which can carry out the fitting of grommets in addition to other operations. For fully automatic machines in particular, it is advantageous if the conversion of the grommet station can be effected from one grommet variant to another rapidly and without errors.

A generically similar grommet station disclosed in EP 1 689 049 A1. The grommet station includes a grommet storage means comprising a drum filled with grommets and a grommet fitting unit for fitting a stripped end of a cable with a grommet. The grommet storage means forms part of a grommet providing unit for providing grommets intended to be fitted, which grommet fitting unit further comprises a conveyor rail of a vibratory conveyor. By means of the conveyor rail, the grommets are conveyed in the correct position to a separating unit, from which grommets are each individually pushed onto a mandrel of a rotary transfer unit comprising four mandrels. In addition to the referenced transfer unit with the four mandrels, the grommet fitting device further comprises a fitting head with an expansion sleeve and a grommet receiving part. At the upper end of the separating unit, an ejection device is arranged with a tappet which can be moved up and down, wherein the tappet in each case feeds the first grommet in the conveyor rail to the transfer device. The transfer device is successively pivotable around a 90° angle, wherein, in a first position, the grommet is pushed onto the mandrel by means of the tappet. After a rotation around 90°, the grommet is pushed in a second position of the transfer unit for the purpose of expansion onto an area of the mandrel with a larger diameter. The actual fitting of the grommet onto the cable end takes place in a third position. In this third position of the transfer device, the grommet is removed from the mandrel using the fitting head, the grommet is pushed onto the expanding sleeve, the grommet is placed on the cable in its expanded state, and finally pushed thereon. Once the mandrel has been pivoted to the third position, the fitting head encloses the grommet with the two-part expanding sleeve and the two-part grommet receiving part, which is formed by two parts as well. In the grommet station according to EP 1 689 049 A1, the grommet providing unit comprising a grommet storage means, vibratory conveyor with a conveyor rail is designed to be mobile and can be exchanged together. However, the parts of the grommet fitting unit that depend on the grommet type and are also referred to as fitting tools must be replaced and assembled by hand during the changeover.

### SUMMARY

One object of the present invention is to provide an improved grommet station which is particularly easy to handle and makes short changeover times possible.

This object and other objects are achieved according to the invention by a grommet station having the features described herein. The grommet station has a grommet fitting unit for fitting cable ends with grommets. Furthermore, the grommet station has a grommet providing unit for providing grommets to be fitted by the grommet fitting unit. The grommet providing unit has at least one grommet storage means. The grommet storage means can, for example, be designed as a drum for the loose storage of grommets. However, the grommet storage means could also be formed by a different store for grommets as bulk material. The grommet station then has a support structure for supporting the grommet fitting unit and the grommet providing unit. Since the grommet fitting unit and the grommet providing unit are rigidly connected to one another and form a common exchangeable module that can be coupled to and uncoupled from the support structure, such that the exchangeable module can be exchanged for another exchangeable module in order to change over to different grommets, the module results in several advantages. The rigid connection of the grommet fitting unit and the grommet providing unit to one another is understood in the present case to mean that the grommet fitting unit and the grommet providing unit form a common machine component (here, an exchangeable module) which, after its completion, basically stays together and individual parts thereof are not removed again. However, the permanent connection does not necessarily mean a non-releasable connection. For example, for repair or maintenance work, it is conceivable that the grommet fitting unit and the grommet providing unit could be separated from one another by means of appropriate fastening means.

With the innovative grommet station, retooling times can once again be significantly reduced. The actual retooling process requires even fewer work steps. The grommet fitting unit and grommet providing unit are permanently interconnected, specifically in such a way that the fitting process can begin immediately after coupling; the grommet fitting unit is then already in the right place in the grommet station. Handling is easy and the risk of using incorrect fitting tools can be eliminated. No special tools are necessary. The arrangement is particularly also suitable for an automated process of changing the exchangeable module.

Fitting tools can be mounted on the grommet fitting device, including, for example, a transfer unit with a mandrel or possibly with a plurality of mandrels, onto which the grommets can be slid. It can be advantageous if all fitting tools and preferably all guides for their movements are integrated in the exchangeable module.

The support structure can be designed to be placed on the floor of a machine shop. It can be advantageous if the support structure is, for example, fixed on a machine table or otherwise integrated into a machine table of the grommet station. However, it is also conceivable for the support structure to also be part of a machine platform of a cable assembly plant. For this reason, the grommet station described here does not necessarily have to be designed as a stand-alone cable processing machine. The fitting station can also be part of a cable assembly plant. In addition to its function of supporting the grommet fitting unit and the grommet providing unit, the support structure can also serve to supply the grommet fitting unit and the grommet providing unit with electrical power and, if required, with compressed air. For this purpose, the support structure can comprise pneumatic and electrical lines to which the grommet fitting unit and the grommet providing unit of the exchangeable module can be connected via corresponding interfaces. The support structure can be designed to be placed on the floor of a machine shop. However, the support structure can also be assigned to a machine platform or table of a cable assembly plant.

The grommet providing unit can have a feed arrangement for feeding grommets from the grommet storage means to the grommet fitting unit. The feed arrangement can, for example, comprise a conveyor rail of a vibratory conveyor. By means of the conveyor rail, grommets can be conveyed one after the other in the correct position in a manner known per se.

It is also advantageous if the exchangeable module can be coupled to and/or decoupled from the support structure without the use of tools.

The exchangeable module can have a guide channel, for example one with a T-shaped cross-section, via which the exchangeable module is or can be inserted into the support structure (and conversely removed therefrom) by pushing it in an insertion direction. For this purpose, the support structure can have a guiding and securing means that complements the guide channel. The guide channel and the guiding and securing means allow the exchangeable module to be coupled to the support structure easily and at the same time precisely.

The aforementioned guiding and securing means can be designed in such a way that they can be actuated automatically. Automatic actuation allows corresponding guiding and securing means to be activated when the exchangeable module is inserted and the end position is reached and allows the exchangeable module to be secured in this position.

To secure the fully inserted exchangeable module, the guide channel can have at least one, and preferably two, recesses and the support structure can have at least one, and preferably two, bolts as securing means, wherein each bolt engages in the associated recess and thus makes it simple to secure the exchangeable module, as mentioned. The aforementioned means for securing the inserted position could also be arranged in reverse, i.e. the bolt(s) would then be assigned to the exchangeable module and the recess(es) to the support structure.

The bolt can be movable transversely to the insertion direction and fastened to the support structure so as to be pretensioned by means of a spring such that it automatically passes through the recess, resulting in an advantageous latching mechanism. The bolt or other securing means can additionally or alternatively also be designed in such a way that it clampingly acts on the counterpart, which is defined by the exchangeable module, in order to secure the position of the fully inserted exchangeable module.

It can be advantageous if all the actuators for operating the grommet providing unit, such as the vibratory conveyor or, if available, the drive for rotating the drum, are integrated in the exchangeable module.

The grommet fitting unit can comprise an expansion sleeve for holding the grommet in the expanded state and for placing the grommet onto the cable end and a transfer unit having at least one mandrel. A fitting head of the grommet fitting unit can further comprise a grommet receiving unit for receiving and holding the grommet during the fitting process. The expansion sleeve and the grommet receiving unit can be mechanically coupled to one another, wherein the expansion sleeve can be inserted into the grommet receiving unit.

Actuators can be provided for operating the grommet fitting unit. At least some of these actuators and preferably all the actuators for operating the grommet fitting unit can be integrated in the exchangeable module. The grommet fitting unit can comprise a transfer unit having at least one mandrel, wherein a grommet can be pushed onto the mandrel in a transfer position. An actuator, which for example comprises an electric motor, can be provided for moving and preferably for rotating or pivoting the transfer unit. At least this actuator, i.e. the actuator for operating the transfer unit, can be integrated in the exchangeable module. If the grommet fitting unit has a separating unit, by means of which grommets are individually pushed from the conveyor rail onto a mandrel of the transfer unit, and an actuator for operating the separating unit, it is advantageous if this actuator—in addition to the actuator for operating the transfer unit—is integrated in the exchangeable module.

The exchangeable module may have connections for forming an interface for signals and power.

To operate the grommet providing unit and/or to operate the grommet fitting unit, one or more control units for controlling the grommet providing unit or the grommet fitting unit can be provided, which are arranged outside the exchangeable module, for example in the support structure. Alternatively, one or more local control units can be provided for operating the grommet providing unit and one or more local control units can be provided for operating the grommet fitting unit, which local control units are integrated in the exchangeable module. Due to such local control units, an advantageous exchangeable module is created that is optimally adapted to the grommets to be processed. The local control units can be connected to a central machine control unit.

It can also be advantageous if all guides for the necessary movements of the individual components or fitting tools of the grommet fitting unit for fitting the grommet onto the cable are provided in the exchangeable module.

The actuators for operating the grommet fitting unit and/or the grommet providing unit of the exchangeable module can be pneumatic actuators, wherein the corresponding valves for controlling the pneumatic actuators are preferably arranged in the exchangeable module. Alternatively, it is also conceivable that the valves for controlling the pneumatic actuators are arranged in the support structure. A cassette having a control unit for controlling the actuators can be arranged on the exchangeable module.

In a preferred embodiment, the grommet station comprises a housing for the grommet providing unit, in which at least the grommet storage means is accommodated. The housing is ergonomically shaped and has an essentially polyhedral and in particular cuboid outer contour with rounded corners and edges of the polyhedron or cuboid, which results in a compact design and makes handling considerably easier, especially with regard to a manual changing process.

The support structure can have a convexity that is designed to complement the housing, preferably a step-like convexity, into which at least a lower region of the housing is or can be fitted when the exchangeable module is fully inserted.

The grommet providing unit of the exchangeable module can have a preferably vertical suction tube that opens into the grommet storage means. By means of the suction tube, grommets can be pneumatically conveyed out of the grommet storage means. The suction tube can be connected to the conveyor rail, which is preferably horizontal, via which the grommets are conveyed further toward the separating unit. The suction tube and the conveyor rail form an advantageous feed arrangement. The suction tube ensures an advantageous compact design of the grommet providing unit and makes possible a particularly ergonomic housing.

The advantageous feed arrangement formed by the suction tube and conveyor rail could also have a different design. Instead of a suction tube, a continuous annular vertical conveyor, as disclosed for example from WO2011/158145, could also be used. The suction tube or the aforementioned vertical conveyor could in some circumstances also be replaced by the known drum. It is also conceivable that the grommets can be fed without a conveyor rail, for example by means of a toothed belt having cams, between which the grommets lie, or even by means of a pick-and-place system of a robot.

The grommet station can consist of a support structure and a plurality of exchangeable modules, whereby one of the plurality of exchangeable modules is coupled to the support structure each time and is therefore ready for operation. Depending on requirements, one exchangeable module can be decoupled from the support structure and replaced by one of the other exchangeable modules. The plurality of exchangeable modules of the grommet station can have different designs; for example, different feed principles can be selected depending on the type of grommet. For example, one exchangeable module may comprise a grommet providing unit having a grommet storage means and a suction tube and another exchangeable module may comprise a grommet providing unit having a drum.

A further aspect of the invention relates to a grommet station having a grommet fitting unit for fitting cable ends with grommets, a grommet providing unit for providing grommets to be fitted by the grommet fitting unit and a support structure for supporting the grommet fitting unit and the grommet providing unit. This grommet station can in particular be constructed as described above, i.e. with an advantageous module consisting of a grommet fitting unit and a grommet providing unit, which forms a common exchangeable module that can be coupled to and uncoupled from the support structure. According to this aspect, the grommet fitting unit and/or the grommet providing unit are designed for the automatic changing of the respective units, i.e. the grommet fitting unit and/or the grommet providing unit. With such a grommet station, the changeover times can be shortened, especially in combination with the exchangeable module consisting of the grommet fitting unit and grommet providing unit. For changing the units automatically, in particular exchangeable modules, the grommet station can have an exchange arrangement comprising a magazine for a plurality of grommet fitting units and/or grommet provision units, in particular for exchangeable modules for different grommets. The exchange arrangement of the grommet station can further comprise an changer for removing a grommet fitting unit and/or a grommet providing unit, in particular for removing an exchangeable module, from the magazine, for transferring it from the magazine to the support structure and for coupling the grommet fitting unit and/or the grommet providing unit and for coupling in particular the exchangeable module to the support structure.

The changer can have a horizontal linear shaft on or by means of which linear shaft a carriage can be moved horizontally back and forth between the magazine and the support structure. The carriage temporarily carries the corresponding unit (for transport between the magazine and the support structure), i.e. the grommet fitting unit, the grommet providing unit or both the grommet fitting unit and the grommet providing unit.

The magazine can have a vertical conveyor with a plurality of vertically movable brackets, on each of which brackets one of the aforementioned units (e.g. an exchangeable module) is or can be placed. Each bracket of the magazine can thus, for example, be designed to carry or accommodate one exchangeable module. In this way, the grommet station can be operated particularly efficiently with regard to switching to other grommet types.

The brackets can be self-propelled and each be equipped with a climbing drive. Preferably, the brackets of the vertical conveyor can be moved vertically by means of lifting or carrying means. Carrying cables, belts or chains can be used as lifting or carrying means. The vertical conveyor could also be a hydraulic or pneumatic vertical conveyor. Preferably, the vertical conveyor can have a bracket support having at least two brackets arranged one above the other, which can be moved along a vertical guide arrangement, for example in the form of a guide rail. The two brackets arranged one above the other are thus combined to form a bracket group and can be moved up and down together.

Each bracket of the vertical conveyor of the magazine can have a clamping unit for securing the transported goods, i.e. the grommet fitting unit, the grommet providing unit or both the grommet fitting unit and the grommet providing unit. In this way, the goods can be safely transported into the desired vertical position using the vertical conveyor.

A further aspect of the invention relates to a grommet station having a grommet fitting unit for fitting cable ends with grommets, a grommet providing unit for providing grommets to be fitted by the grommet fitting unit and a support structure for supporting the grommet fitting unit and the grommet providing unit. This grommet station can in particular be constructed as described above, i.e. with an advantageous module consisting of a grommet fitting unit and a grommet providing unit, which forms a common exchangeable module that can be coupled to and uncoupled from the support structure. The grommet station according to this aspect is characterized by having a protective cover for covering the grommet station and that the protective cover has a filling opening for filling the grommet storage means with grommets. Due to this special protective cover, grommets can be refilled easily and safely without the need to remove the protective cover. Regions of the grommet station that persons standing nearby could access with their hands are in particular covered. The protective cover prevents persons from being able to reach into the grommet station and from being injured by moving machine elements of the grommet station. The protective cover therefore covers the grommet station in particular at least at the sides and at the top. A cover is not required at the bottom, but is conceivable. The specially designed protective cover could also be used in an advantageous manner with a grommet station having a conventional design such as the grommet station that has become known from EP 0 626 738 B1.

A preferably closable filling opening can be provided in the protective cover for filling and in particular for refilling the grommet storage means with grommets.

An inlet can be arranged at the filling opening. Preferably, the inlet projects from the protective cover. In other words, the inlet is arranged projecting from the protective cover. The inlet can be fixed, but it is also possible to have a movable inlet that can be put into a closed position when not in use. In the latter case, the filling opening can be closed by the closed inlet. In the open position, the inlet can project at an angle from the protective cover in order to facilitate filling, and in the closed position can rest against the protective cover.

The inlet can be funnel-shaped, which makes it easy to ensure that no grommets accidentally miss the inlet during filling.

The housing for the grommet providing unit may comprise a cover, wherein an opening and closing mechanism is provided to open the cover, and vice versa. The housing can have a lower part of the housing and the aforementioned cover, wherein the cover is preferably arranged on the upper side of the lower part of the housing. The cover can further preferably be pivotally fastened to the lower part of the housing via a hinge. The pivot movement to open the cover of the housing can be performed manually or automatically by means of an appropriate actuator.

A special variant can be aimed at the housing for the grommet providing unit comprising a cover, wherein the opening and closing mechanism for the inlet is designed to simultaneously open the cover during the opening process of the inlet.

For easy handling, at least one handle can be provided for manually opening and closing the filling opening and/or the cover.

The opening and closing mechanism for the cover comprises, for example, a slide. By means of the slide, which can preferably be moved back and forth by the at least one handle, the cover can be moved into the open position or into the closed position.

Lateral guide elements can be arranged on the inside of the cover on the slide and connect to the inlet when the cover and/or the closable filling opening is/are in the open position. The inlet may in turn comprise lateral guide elements which, for filling purposes or in the open position, are located approximately at the same level as the guide elements of the slide. The guide elements ensure reliable filling with grommets.

A pin (or other engagement member) may be arranged on the cover, the pin being operatively connected to a wedge-shaped flank portion of the slide for opening the cover. The flank portion forms a guide for the pin along which it can move. By the movement of the slide in the opening direction, the pin is pushed away as it travels along the flank portion, thus instigating the process of opening the cover.

### DESCRIPTION OF THE DRAWINGS

Further individual features and advantages of the invention emerge from the following description of exemplary embodiments and from the drawings. In the drawings:

FIG. 1: is a perspective view of a grommet station according to a first exemplary embodiment, comprising a support structure and a decoupled exchangeable module,

FIG. 2: shows the grommet station from FIG. 1 comprising the exchangeable module coupled to the support structure (exchangeable module fully inserted),

FIG. 3: is an enlarged detailed sectional view of a coupling arrangement for securing the fully inserted exchangeable module,

FIG. 4: is a cut-away view of the grommet station from FIG. 2 comprising a housing,

FIG. 5: is an enlarged perspective detailed view of a grommet fitting unit (without fitting head) of the exchangeable module,

FIG. 6 to FIG. 8: show a side view of the grommet fitting unit of the exchangeable module in three different positions, whereby a stripped cable end is fitted with a grommet,

FIG. 9: is a plan view of a cable assembly plant having a grommet station of the type according to the first exemplary embodiment, whereby the grommet station is, however, equipped with an exchange arrangement for changing exchangeable modules,

FIG. 10: is a perspective view of the exchange arrangement of the grommet station according to the second exemplary embodiment,

FIG. 11: shows the grommet station comprising the exchange arrangement from FIG. 10 with two exchangeable modules,

FIG. 12 to FIG. 16: show the grommet station comprising the exchange arrangement with the two exchangeable modules in different positions when changing from one exchangeable module to the other exchangeable module,

FIG. 17: is a perspective partial view of a cable assembly plant, wherein a grommet station of the cable assembly plant is covered by a protective cover,

FIG. 18: is another perspective view of the grommet station from FIG. 17,

FIG. 19: shows the grommet station comprising a housing of a grommet providing unit which is half-open, and

FIG. 20: shows the grommet station with the housing fully open.

### DETAILED DESCRIPTION

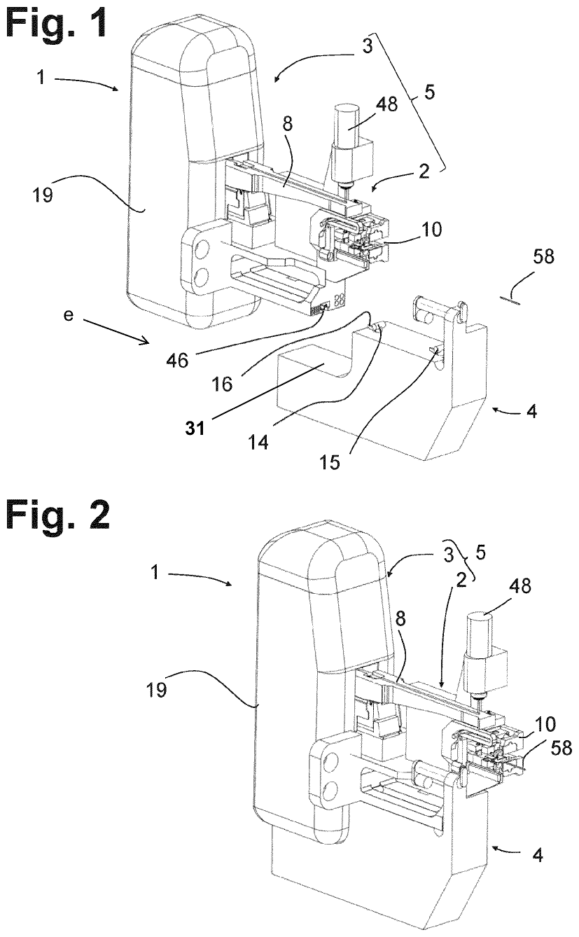

FIG. 1 shows a grommet station, denoted as a whole by 1, comprising a grommet fitting unit 2 for fitting cable ends with grommets, a grommet providing unit 3 for providing grommets to be fitted by the grommet fitting unit, and a support structure 4 for supporting the grommet fitting unit 2 and the grommet providing unit 3. The grommet fitting unit 2 and the grommet providing unit 3 are permanently interconnected. As can be seen from FIG. 1, the two units 2 and 3 form a common module 5. This module 5 can be coupled to the support structure 4 and uncoupled therefrom again. Hereinafter, the module 5 will be referred to as an exchangeable module, since such modules can be easily exchanged for changing over from one type of grommet to another type of grommet by means of the grommet station explained in detail below. The exchangeable modules 5 can each be loaded with different grommets (for example grommets of different colors and/or grommet geometries), whereby the exchangeable module 5 is adapted to the grommet geometry. At a grommet change, i.e. a change from one type of grommet to another, the exchangeable module 5 shown here can be exchanged for another exchangeable module (not shown here), which can significantly shorten changeover times. The other exchangeable module mentioned is essentially constructed in the same way and differs substantially only in being loaded with different grommets and in the fact that it is adapted to the grommets or is set up for these grommets.

The grommet providing unit 3 for providing grommets for the grommet fitting unit 2 comprises a grommet storage means accommodated in a housing 19. This grommet storage means is shown in FIG. 4 that follows, where it is denoted by reference numeral 6. The grommet storage means is designed to store grommets as bulk material. The grommet providing unit 3 further comprises a conveyor rail 8, by means of which grommets can be conveyed in the direction of the grommet fitting unit 2. The conveyor rail 8 is part of a vibratory conveyor. The actuator for operating the vibratory conveyor is denoted by reference numeral 47. The conveyor rail 8 has a groove in the longitudinal direction, the cross-section of which approximately corresponds to the outline of the longitudinal section of a grommet. A separating unit 48 is arranged at the end of the conveyor rail 8. By means of the conveyor rail 8, the grommets are conveyed in the correct position to the separating unit 48, from which each grommet is individually pushed onto a mandrel of a transfer unit. The separating unit 48 and the transfer unit with the mandrel are components of the grommet fitting unit 2, which further comprises a fitting head 10. The grommet fitting unit 2 comprising the aforementioned components will be explained in more detail later on the basis of FIG. 4 to FIG. 8.

The support structure 4 can, for example, be fastened to a machine table (not shown). However, the support structure 4 could also be designed to be placed on the floor of a machine shop.

The support structure 4 has two bolts 14, 15 and centering elements 16 arranged in front of the bolts. The exchangeable module 5 has a guide channel 46 with a T-shaped cross-section, via which the exchangeable module 5 can be inserted into the support structure 4 by being pushed in the e insertion direction. The pointed centering elements 16, which are triangular when viewed from above, facilitate insertion. The bolts 14, 15 serve as guiding means during insertion of the exchangeable module 5.

The support structure 4 forms a stationary structure of the grommet station 1, while the exchangeable module 5 is designed to be mobile.

The housing 19 for the grommet providing unit 3 is ergonomically shaped and has an approximately cuboid outer contour with rounded corners and edges, whereby the exchangeable module 5 is easy to handle and in particular also makes possible an easy manual changing process. The support structure 4 has a step-like recess 31 which is complementary to the housing 19 and into which the lower region of the housing 19 can be fitted.

The fully inserted exchangeable module 5 is shown in FIG. 2. In this coupled position, the grommet station 1 is ready for operation. It can also be seen from this that due to the ergonomically shaped, comparatively narrow housing 19, an altogether compact and space-saving design of the grommet station 1 is achieved.

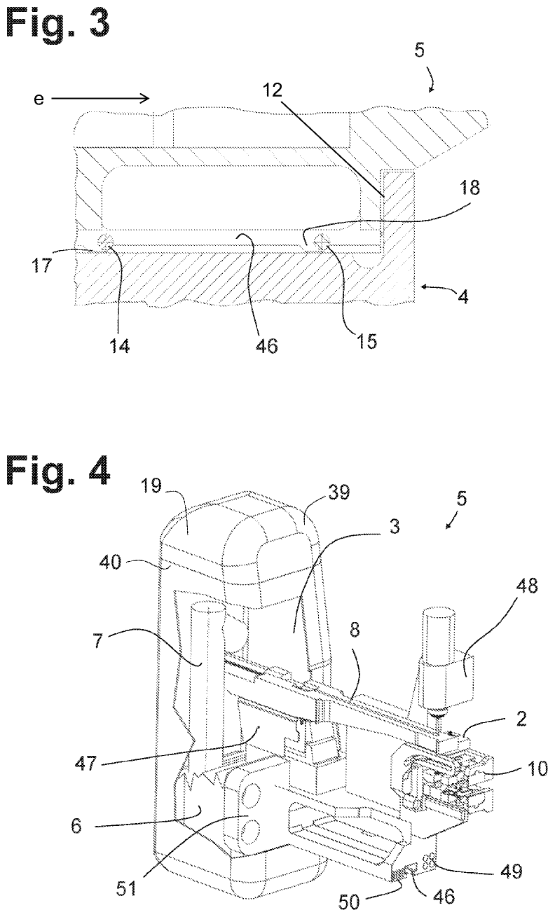

Details regarding the design of the coupling arrangement for guiding and securing the exchangeable module 5 can be found in FIG. 3. The guide channel 46 of the exchangeable module 5 has two recesses 17, 18 into which the bolts 14, 15 engage when the exchangeable module is fully inserted. The bolts 14, 15 can be moved transversely to the insertion direction e and can be pretensioned by means of a spring (not shown) so that the bolts 14, 15 each pass automatically into the corresponding recess 17, 18, thereby creating a latching mechanism. In the present embodiment, the bolts 14, 15 are designed as clamping bolts. As soon as the target position is reached during insertion of the exchangeable module 5 into the support structure 4, the two clamping bolts 14, 15 are moved downward into the recesses 17, 18. The recesses 17, 18 are designed such that a component of the clamping force acts forward in the e direction and presses the exchangeable module 5 against a stop 12 of the support structure 4. In this way, a stable and reliable connection between the support structure 4 and the exchangeable module 5 is ensured.

It is advantageous if the clamping bolts 14, 15 are pulled downward by springs and are only actively pushed upward for the insertion of the exchangeable module 5. This can be done by active elements, such as a pneumatic cylinder, or passively, for example by means of a lever mechanism (not shown). In the case of the active elements mentioned, clamping can be initiated automatically by means of a position sensor when the target position is reached; alternatively, clamping could also be initiated by pressing a button. The coupling arrangement can also be released to release the securing system by means of a button or by means of a control signal sent by a control unit.

As can be seen from FIG. 4, the grommet providing unit 3 has a grommet storage means 6. The grommet storage means 6 is formed by a container which in the present case is immovably accommodated in the housing 19. In the grommet storage means 6, grommets are stored as bulk material. The grommet providing unit further comprises a vertical suction tube 7, which opens into the grommet storage means 6 and with which grommets can be pneumatically conveyed out. Via the suction tube 7, grommets can be conveyed from the grommet storage means 6 to the already previously mentioned horizontal conveyor rail 8.

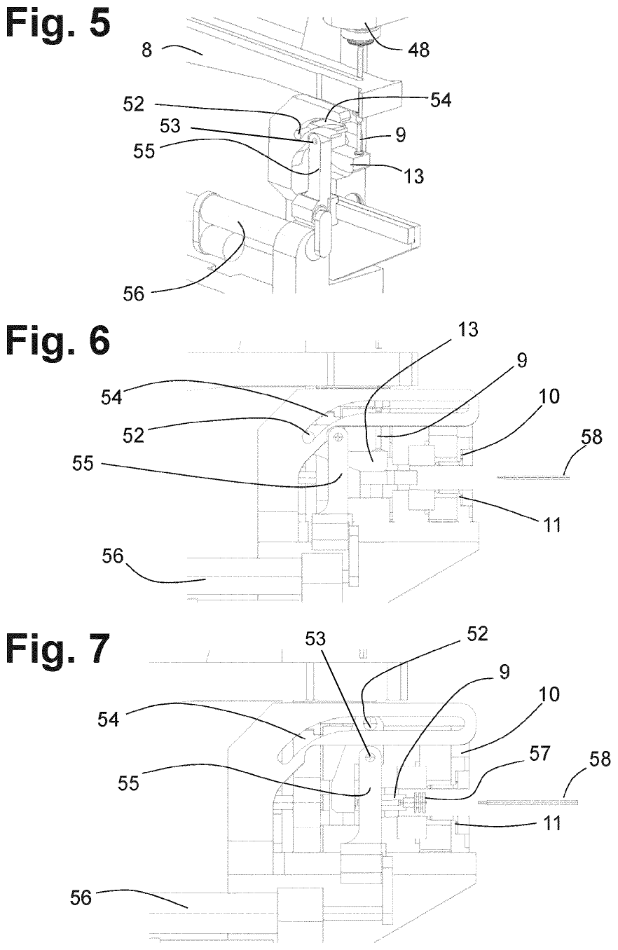

Except for a linear unit 56 (FIG. 5) for moving the mandrel of the fitting head 10 of the grommet fitting unit 2, all the actuators, such as the actuator 47 of the vibratory conveyor comprising the conveyor rail 8, for operating the grommet fitting unit 2 and the grommet providing unit 3 are integrated in the exchangeable module 5. However, it would also be conceivable to assign the linear unit 56 to the exchangeable module 5 instead of—as shown—to the support structure 4. In this case, all the actuators for operating the grommet fitting unit 2 and the grommet providing unit 3 would be integrated in the exchangeable module 5.

The interface for supplying the various actuators of the exchangeable module 5 with power and for controlling each of the components can also be clearly seen in FIG. 4. Pneumatic lines 49 and electrical lines 50 are provided for supply. The respective lines 49, 50 are connected to one another during the insertion process, for example via a plug-in connection, which is only shown in outline, in the interface between the support structure 4 and the exchangeable module 5.

Furthermore, FIG. 4 shows a coupling element 51 with two holes for coupling the exchangeable module 5 to a carriage (not shown) of an exchange arrangement, which is shown in FIG. 10 to FIG. 16 and explained in detail below with reference to these figures. This coupling element 51 could also be omitted for the manual changing process.

The housing 19 of the grommet providing unit 3 comprises a cover 39, via which the grommet storage means 6 can be filled with grommets when the cover is open. The cover 39 is pivotably fastened to a lower part of the housing 40 of the housing 19, for example via a hinge.

Structural details relating to the design of the grommet fitting unit 2 for fitting cable ends with grommets are shown in FIG. 5. The grommet fitting unit 2 comprises a transfer unit with a mandrel carrier 13 and a mandrel 9 fastened thereto. The mandrel carrier 13 is pivotably mounted on a cantilever arm 55. The corresponding pivot axis is denoted by reference numeral 53. The cantilever arm 55 can be moved in the horizontal direction by means of a linear unit 56. The linear movement of the cantilever arm is effected by this linear unit, for example a spindle drive having a servomotor, which is arranged on the support structure 4. During insertion of the exchangeable module 5, the cantilever arm 55 is coupled to the linear unit 56, for example magnetically. A control pin 52 is attached to the mandrel carrier 13, which engages in a control cam 54 and can be guided therein. The linear movement of the cantilever arm 55 causes the mandrel carrier to be rotated by 90° and then moved linearly. FIG. 6 to FIG. 8 show the mode of operation of the fitting head 10 and the fitting process and in particular the movements of the mandrel 9.

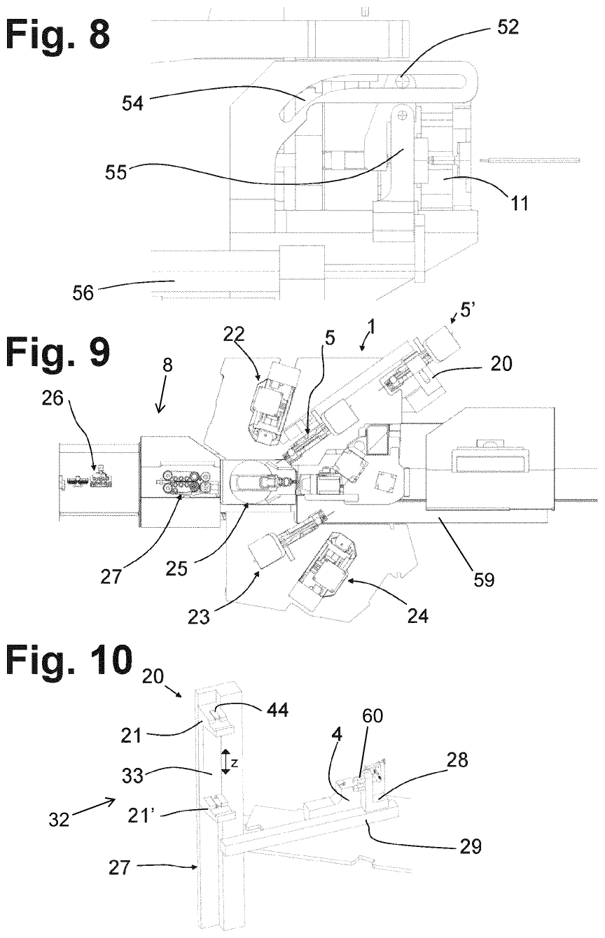

In the initial position according to FIG. 6, the mandrel 9 is in a vertically upright position. In this position, a grommet can be pushed from the conveyor rail 8 onto the mandrel 9 by means of the separating unit 48. The cantilever arm 55 is then moved a first distance to the right by means of the linear unit. The linear movement of the cantilever arm causes the mandrel 9 to pivot by 90°. This position is shown in FIG. 7. The fitting head 10 is then moved into a closed position in order to engage around the grommet, denoted here by reference numeral 57, with stripper jaws. With a further linear movement of the cantilever arm 55, the mandrel 9 is pushed into the closed expansion sleeves (FIG. 8). As the fitting process continues, the fitting head 10 moves in the direction of the cable 58. This frees the mandrel 9 again and it can be moved into the initial position by the linear unit 56 in order to accept the next grommet. The cable 58 is guided to the grommet fitting unit 2 by a gripper (not shown). Such a grommet station 1 corresponds to a fully automatic design as regards fitting grommets. Of course, it would however also be conceivable to design the grommet station 1 to be semi-automatic, in which cables are brought to the grommet fitting unit 2 by hand, or in other variants, instead of fully automatically.

The grommet station 1 with the permanently interconnected grommet fitting unit 2 and grommet providing unit 3, which form a common exchangeable module 5 that can be coupled to and uncoupled from the support structure 4, could, however, also have a different design to that in the exemplary embodiment shown here. For example, an alternative grommet fitting unit could be used as is disclosed in EP 3 651 288 A1. The grommet fitting device of the grommet station could also have a plurality of mandrels, such as the grommet fitting device with the four mandrels known from EP 0 626 738 B1. The exact design and mode of operation of these grommet fitting units can be found in the afore-mentioned publications, to which reference is made.

According to the present embodiment, the exchangeable module 5 comprises a grommet storage means 6 having a container and a suction tube 7. However, the grommet providing unit 3 could have a different structure, for example the suction tube could be replaced by a conveyor belt. It is also conceivable to design the grommet storage means as a drum, as is disclosed, for example, in EP 0 626 738 B1.

The concept presented for the support structure 4 and the mobile exchangeable module 5 also allows the use of exchangeable modules based on other principles for sorting and fitting the grommets. This can be primarily achieved by all fitting tools and all guides for the movement of the tools being integrated in the exchangeable module. The greatest flexibility in terms of the design of the cassette is achieved when all the actuators for moving the fitting tools and ideally for sorting and supplying the grommets are also integrated in the exchangeable module 5. If the exchangeable module 5 is to be designed as cost-effectively as possible, it may also be useful to integrate some or even all the actuators in the support structure 4. In the exemplary embodiment according to FIG. 1 to FIG. 8, this is realized for one movement, namely the pivoting and sliding movement of the mandrel 9 of the grommet fitting unit 2. The remaining movements of the grommet fitting unit 2 are carried out, for example, by pneumatic cylinders for forming pneumatic actuators, which are integrated in the exchangeable module 5.

If these pneumatic actuators are integrated in the exchangeable module 5, their electrical switching valves can be arranged either in the support structure 4 or in the exchangeable module 5. In the first case, the switched supply air of the actuator is transmitted via the interface, in the second case it is the control signals. In general, part of the control system for operating the grommet station can also be located in the exchangeable module 5. This would make it possible, for example, to use a bus system to reduce the number of control lines in the interface.

The grommet providing unit 3 and the grommet fitting unit 2 can be controlled via a control unit (not shown) arranged outside the exchangeable module 5. However, it is also conceivable for them to be controlled in other ways. For example, local control units could be provided for operating the grommet providing unit 3 and for operating the grommet fitting unit 2, which local control units are integrated in the exchangeable module 5. The local control units can be connected to a central machine control system.

The grommet station can have a common exchangeable module that can be coupled to and uncoupled from a support structure and consists of a grommet fitting unit and a grommet providing unit, which grommet station is designed for changing the exchangeable module automatically. Such a grommet station is shown in FIG. 9. The grommet station 1 is part of a cable assembly plant in this case. The cable assembly plant designed as a swivel machine for assembling cables (not shown here) comprises a feed unit 8 having a straightening arrangement 26 and a cable conveyor 27 designed as a belt conveyor, which brings the cables along the longitudinal axis of the plant to the first pivoting unit 25. The pivoting unit 25 has a gripper for holding the cable. A stripping station for cutting the cable to length and stripping the cable is arranged on the longitudinal axis of the machine. Two crimping stations 22, 24 and grommet stations 1, 23 are arranged next to the machine longitudinal axis. The processing stations 22 and 1 are assigned to the leading cable end; the processing stations 24 and 23 serve to assemble the trailing cable ends. Such cable assembly plants are described, for example, in EP 1 251 605 A1, wherein the present cable assembly plant has a novel grommet station 1.

Two exchangeable modules 5, 5′ of the grommet station 1 of the cable assembly plant can be seen. The exchangeable module 5 is coupled to a support structure and is ready for operation. The second exchangeable module 5′ is in a kind of parking position. For automatically changing the exchangeable modules 5, 5′, an exchanging arrangement comprising a magazine for a plurality of exchangeable modules for different grommets and an exchanger for removing an exchangeable module from the magazine, for transferring it from the magazine to the support structure and for coupling the exchangeable module to the support structure is provided, which is shown below in FIG. 10 to FIG. 16 and described in detail with reference to these figures.

For a better understanding of the basic structure, FIG. 10 shows the afore-mentioned exchange arrangement without exchangeable modules. The exchange arrangement according to this embodiment comprises a magazine 20 for two exchangeable modules. The magazine 20 contains a vertical conveyor with two vertically movable brackets 21, 21′, on each of which an exchangeable module can be placed. The changer has a horizontal linear shaft 29, by means of which a carriage 28 can be moved back and forth between the support structure 4 and the magazine 20. The carriage 28 is used for horizontally transporting an exchangeable module. The support structure 4 on the one hand and the exchangeable module 5 on the other hand have approximately the same design as those according to the first exemplary embodiment in FIG. 1 to FIG. 8. One difference-in addition to the exchanging arrangement for automatic changing-is that in this case the support structure 4 is fastened to a machine table 59 of the cable assembly plant.

The vertical conveyor 32 has a bracket support 33 having two brackets 21, 21′ arranged one above the other. The bracket support 33 combines the two brackets to form a collectively movable bracket group. In order to move the bracket support 33 in the z direction, for example, carrying cables or belts or other lifting or carrying means can be used. The bracket support 33 can be moved by means of lifting or carrying means along a vertical guide arrangement in the form of a guide rail, wherein the lifting or carrying means are set in motion by means of drives (not shown here). A hydraulic or pneumatic vertical conveyor or a vertical linear shaft is also conceivable.

From FIG. 10 it can further be seen that each bracket 21, 21′ has a clamping unit 44 for securing the transported exchangeable module.

In order to couple the exchangeable module 5 for horizontal transportation, the carriage 28 has a coupling part 60 in the form of a counterpart for the coupling element 51. It can be seen that the coupling part 60 has two cylindrical extensions which are designed to be complementary to the two holes of the coupling element 51. On account of these coupling means 51, 60, the carriage temporarily carries the exchangeable module (for transportation between the magazine 20 and support structure 4).

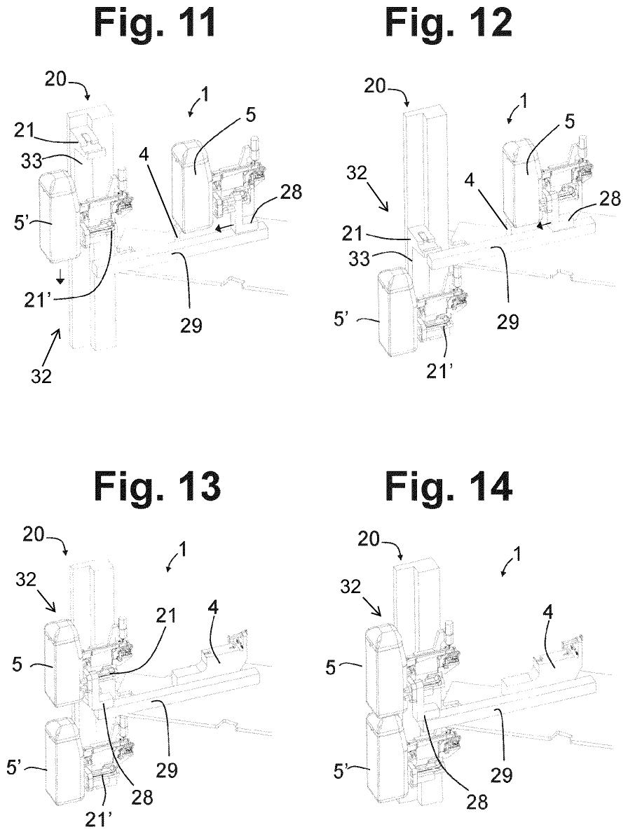

The procedure for changing modules is shown in FIG. 11 to FIG. 16. FIG. 11 shows the initial position: the exchangeable module 5 is inserted into the support structure 4 and the carriage 28 is not connected to the exchangeable module 5. In the magazine 20, the exchangeable module 5′ is in a position at which the exchangeable module 5′ could be removed from the magazine 20 by hand.

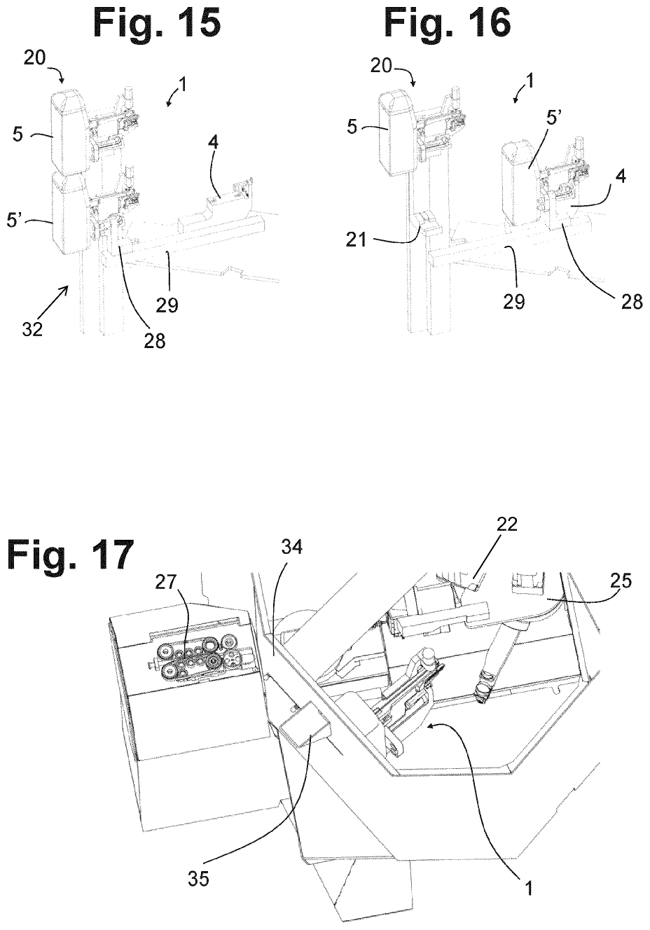

In FIG. 12, the carriage 28 has moved to the left and has coupled the exchangeable module 5. In order to separate the exchangeable module 5 from the support structure 4, the bolts (14, 15) are then undone. The bracket support 33 of the vertical conveyor 32 of the magazine 20 has been moved downward in order to bring the upper bracket 21 to beneath the linear shaft 29. In FIG. 13, the carriage 28 has moved into the magazine 20 and the exchangeable module 5 is located above the upper bracket 21. The vertical conveyor 32 then moves upward and picks up the exchangeable module 5, which is clamped onto the bracket 21 (FIG. 14). In order to change to the exchangeable module 5′, the carriage 28 separates from the exchangeable module 5 and moves slightly to the right so that the vertical conveyor 32 can move upward, as described above (FIG. 15). The carriage 28 couples the lower exchangeable module 5′ and brings it to the support structure 4, in which it is inserted and secured (FIG. 16).

FIG. 17 shows a detail of another cable assembly plant which comprises at least one grommet station 1 of the type according to the first exemplary embodiment. The grommet station 1 comprises a protective cover 34 for covering the grommet station. In the present case, the protective cover 34 covers further processing stations of the cable assembly plant shown by way of example, such as the swivel unit 25 and the crimping station 22. Of course, such a protective cover 34 could also be provided to a stand-alone grommet station or to one or more grommet stations of cable assembly plants having a plurality of processing stations.

A filling opening is provided in the protective cover 34 for filling or refilling the grommet storage means 6 with grommets. An inlet 35 is arranged in the protective cover 34 in the region of the filling opening. The housing 19 for the grommet providing unit 3 comprises a cover 39 which is pivotally fastened to the lower part of the housing 40 via a hinge. The grommet station 1 has an opening and closing mechanism to open the cover 39 (and vice versa), which is described in detail below.

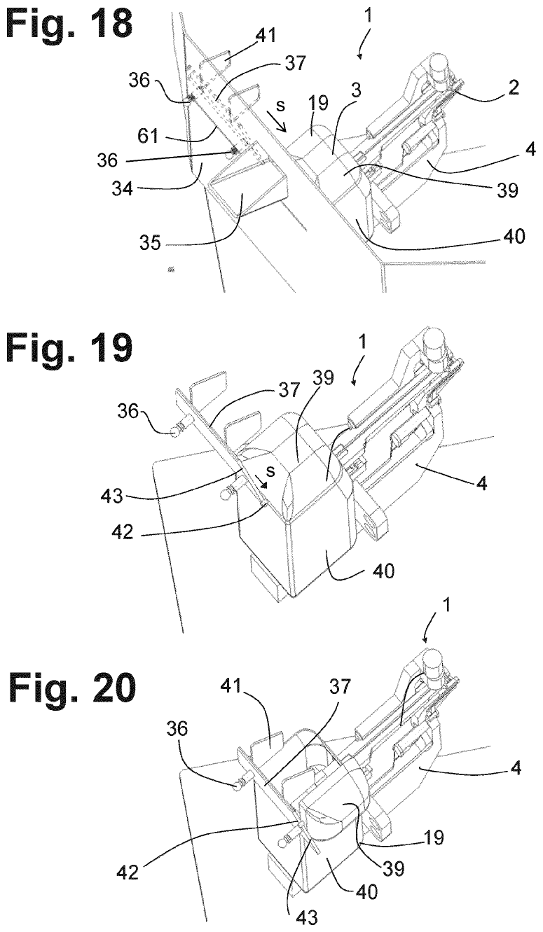

The pivoting movement for opening the housing 19 is carried out manually in this case. For opening and closing the cover 19, as can be seen from FIG. 18, for example, two handles 36 are provided which are connected to a slide 37 guided along a horizontal slot 61. A pin 42 is arranged on the cover 39 and is operatively connected to a wedge-shaped flank portion 43 of the slide 37 for opening the cover. The flank portion 43 forms a guide for the pin 42, along which it can move. In FIG. 18, the cover 39 is in a closed position. By moving the slide 37 in the opening direction s, the pin 42 is pushed away by moving on the flank portion 43, thus initiating the opening process for the cover 39. FIG. 19 shows the cover 39 in an intermediate position (cover 39 approximately half-open). FIG. 20 shows the cover 39 in the open position.

Lateral guide elements 41 are arranged on the inside of the cover on the slide, which, when the cover 39 is in the open position, connect to the inlet 35. The inlet 35 in turn also comprises lateral guide elements which are located approximately on the same level as the guide elements 41 of the slide 37. These guide elements ensure reliable filling of the grommet storage means 6 with grommets.

In accordance with the provisions of the patent statutes, the present invention has been described in what is considered to represent its preferred embodiment. However, it should be noted that the invention can be practiced otherwise than as specifically illustrated and described without departing from its spirit or scope.

1-16. (canceled)

17. A grommet station comprising:
a grommet fitting unit adapted to fit cable ends with grommets;
a grommet providing unit having a grommet storage means;
a support structure supporting the grommet fitting unit and the grommet providing unit; and
wherein the grommet fitting unit and the grommet providing unit are permanently interconnected forming an exchangeable module that is adapted to be coupled to and uncoupled from the support structure.

18. The grommet station according to claim 17 wherein the exchangeable module has a guide channel via which the exchangeable module is inserted into the support structure.

19. The grommet station according to claim 18 wherein the guide channel includes at least one recess and the support structure has at least one bolt, the at least one bolt engaging in the at least one recess and securing the exchangeable module when the exchangeable module is inserted into the support structure.

20. The grommet station according to claim 17 including a plurality of actuators for operating the grommet fitting unit and the grommet providing unit being integrated in the exchangeable module.

21. The grommet station according to claim 17 wherein the grommet providing unit includes a housing in a grommet storage means is accommodated, the housing being ergonomically shaped and having a polyhedral outer contour.

22. The grommet station according to claim 21 wherein housing has a cuboid outer contour with rounded corners and edges of the cuboid contour.

23. The grommet station according to claim 21 wherein the support structure has a stepped recess that is complementary to the housing and into which a lower region of the housing fits.

24. The grommet station according to claim 17 wherein the grommet providing unit has a suction tube that opens into a grommet storage means of the grommet providing unit.

25. The grommet station according to claim 17 including an exchange arrangement that automatically exchanges the exchangeable module for another exchangeable module having another grommet fitting unit and another grommet providing unit.

26. The grommet station according to claim 25 wherein the exchange arrangement includes a magazine storing the another exchangeable module, the magazine including a vertical conveyor having vertically movable brackets on one of which the another exchangeable module is placed.

27. The grommet station according to claim 26 wherein the one bracket has a clamping unit securing the another exchangeable module placed thereon during a lifting movement of the vertical conveyor.

28. The grommet station according to claim 26 including a changer having a movable horizontal linear shaft adapted to remove the exchangeable module from the support structure, to remove the another exchangeable module from the magazine, to transfer the another exchangeable module from the magazine to the support structure and to couple the exchangeable module to the support structure.

29. The grommet station according to claim 17 wherein the grommet providing unit includes a grommet storage means, the grommet station including a protective cover covering the grommet station, the protective cover having a filling opening for filling the grommet storage means with grommets.

30. The grommet station according to claim 29 including an inlet arranged at the filling opening.

31. The grommet station according to claim 29 wherein the filling opening is closable, the grommet providing unit including an opening and closing mechanism for opening and closing the filling opening, the opening and closing mechanism adapted to be activated from outside the protective cover.

32. The grommet station according to claim 31 including at least one handle for manually opening and closing the filling opening.

33. The grommet station according to claim 32 wherein the opening and closing mechanism includes a slide moveable back and forth by the at least one handle.
